(19) United States
(12) Patent Application Publication
(10) Pub. No.: US 2026/0357777 A1
(43) Pub. Date: Nov. 12, 2026

(54) CONTROL DEVICE FOR ENGINE IGNITION, CONTROL METHOD THEREOF AND CONTROL PROGRAM

(71) Applicant: SHINDENGEN ELECTRIC MANUFACTURING CO., LTD., Tokyo (JP)

(72) Inventor: Tomohiro KUROKAWA, Saitama (JP)

(21) Appl. No.: 19/659,309

(22) Filed: Apr. 27, 2026

(30) Foreign Application Priority Data
May 12, 2025 (JP) 2025-079352

(51) Int. Cl. F02P 5/15

(52) U.S. Cl. CPC F02P 5/15

(57) ABSTRACT

A engine drives an AC generator. A waveform shaping circuit outputs a rotation pulse signal that rises to H level at a rising edge of a rotation detection signal and falls to L level at a falling edge. Upon a control unit detects a rising edge of the rotation pulse signal in a low-speed rotation mode of the engine, the control unit supplies a current to a primary winding of an ignition coil. Subsequently, upon the control unit detects the falling edge of the rotation pulse signal, it generates a high voltage in a secondary winding of the ignition coil, thereby igniting the spark plug.

### FIELD OF THE INVENTION

The present invention relates to an engine ignition device for igniting the engine of a portable engine generator, a motorcycle, or the like, a control method thereof, and a non-transitory storage medium storing an engine ignition control program.

### BACKGROUND OF THE INVENTION

Conventionally, transistor ignition devices have been known as engine ignition devices for portable engine generators, motorcycles (JP2012-229654A, JP2012-7576A and JP11-200875A).

The main components of a transistor ignition system are an alternator, a battery, an ignition control circuit, and an ignition coil.

The ignition control circuit stores energy by passing current from the battery to the primary winding of the ignition coil upon the transistor is turned on. The ignition control circuit then cuts off the current by turning off the transistor, causing a sudden change in current, generating a high voltage in the secondary winding of the ignition coil, and applying the high voltage to the spark plug to ignite it.

The alternator also has a pulser coil that functions as a rotation detector used to control the engine ignition timing. A reluctor (protrusion) is placed on the engine shaft side relative to the pulser coil. For example, if one reluctor is installed, a positive rising signal and a negative falling signal are output each time the reluctor passes by the pulser coil.

FIGS. 6A to 6G are time charts of ignition control by a conventional ignition control device. Note that FIG. 6A shows a rotation detection signal (pulsar coil detection signal), FIG. 6B shows a rotation pulse signal, FIG. 6C shows an intake pressure, FIG. 6D shows a piston stroke, FIG. 6E shows a current start timer, FIG. 6F shows the ignition timer, and FIG. 6G shows an ignition drive signal (transistor drive signal). Also, “TDC” is an abbreviation for “Top Dead Center” and “BDC” is an abbreviation for “Bottom Dead Center.”

The rotation detection signal in FIG. 6A is a signal that changes between positive and negative upon the reluctor (protrusion) provided on an outer periphery of a rotor disposed on the crankshaft passes through a pulser coil. The rotation pulse signal in FIG. 6B is a signal obtained by shaping the rotation detection signal using a waveform shaping circuit, and is a signal that changes to H level at the positive rising edge of the rotation detection signal and changes to L level at the negative falling edge of the rotation detection signal.

The pulser coil outputs a positive rising signal and a negative falling signal upon the reluctor passes an advance position before the TDC of the engine, for example, 75 degrees before top dead center (BTDC 75 degrees). The rotation pulse signal is generated in synchronization with this rotation detection signal, and the time t1 at which the rotation pulse signal falls from H level to L level corresponds to 75 degrees before top dead center (BTDC 75 deg).

Here, since the ignition angle (ignition timing) is preset in accordance with the engine characteristics, the time T2 from the fall of the rotation pulse signal at 75 degrees before top dead center to ignition is calculated using the following equation: In the following equation, the angle from 75 degrees before top dead center to the ignition angle is calculated, and then the calculated angle is converted from the rotation speed at that time into time.

T2=[(75 deg.−ignition angle)/360°]·(60 sec/rotation speed)

Additionally, the current flow time T3, during which current flows through the primary winding of the ignition coil, is preset based on the characteristics of the ignition coil. Therefore, the time T1 from 75° before top dead center to the start of current flow can be calculated as follows:

T1=(time to ignition T2)−(current flow time T3)

Upon the rotation pulse signal falls, the ignition control circuit sets a time T1 until the start of energization in a power-on start timer, and also sets a time T2 until ignition in an ignition timer, and starts both. Upon the time T1 set by the current start timer has elapsed, the transistor is turned on to allow current to flow through the primary winding of the ignition coil, storing energy. Next, upon the time T2 set by the ignition timer has elapsed, the transistor is turned off, generating a high voltage in the secondary winding of the ignition coil, which is applied to the spark plug to ignite it.

However, in ignition control using such conventional ignition control devices, upon the engine is running at low speeds, such as upon starting, the engine speed changes suddenly after the timer is set, which can result in ignition not occurring at the intended ignition angle, potentially reducing the engine's startability.

### SUMMARY OF THE INVENTION

An object of the present invention is to provide an engine ignition device that can eliminate variations in ignition timing during low-speed rotation and improve startability, a control method therefor, and non-transitory storage medium storing an engine ignition control program.

### Engine Ignition Device: Low-Speed Ignition Control

The present invention is an engine ignition device that repeats intake, compression, combustion, and exhaust, comprising:
a rotational pulse detector that outputs a rotation pulse signal that changes to one of two logic levels at a first angle before top dead center and changes to the other of two logic levels at a second angle that is closer to top dead center than the first angle, for each revolution of the engine;
a rotation speed detection unit that detects the engine rotation speed from the period of change in the binary logic level of the rotation pulse signal to one side or the other side;
a low-speed current control unit that, upon a low-speed rotation mode in which the engine rotation speed is equal to or lower than a threshold rotation speed is determined, determines whether the rotation pulse signal changes to one of the binary logic levels and turns on a switching element to supply a current to a primary winding of an ignition coil, thereby charging energy in the primary winding; and
a low-speed current cutoff control unit that determines whether the binary logic level of the rotation pulse signal changes to the other, cuts off the supply of current to the primary winding of the ignition coil by turning off the switching element, generates a high voltage in a secondary winding, and applies the high voltage to the spark plug to ignite the spark plug.

### High-Speed Ignition Control

The engine ignition device in claim 1 further comprising:
a timer control unit that, upon a high-speed rotation mode in which the rotation speed of the engine exceeds the threshold rotation speed is determined, determines whether the binary logic level of the rotation pulse signal changes to one of the two values, and sets a current start timer to a first timer time until current supply starts, and sets an ignition timer to a second timer time until ignition starts, thereby activating the timers;
a high-speed current control unit that supplies current to the primary winding of the ignition coil by turning on the switching element upon the first timer time of the current start timer has elapsed, thereby charging energy in the primary winding; and
a high-speed current cutoff control unit that, upon the second timer time of the ignition timer has elapsed, cuts off the current supplied to the primary winding of the ignition coil by turning off the switching element, generates a high voltage in the secondary winding, and applies the high voltage to the spark plug to ignite the spark plug.

### Rotational Pulse Detection Unit

The rotational pulse detection nuit in which includes a rotation detector and a waveform shaping circuit;
wherein the rotation detector includes:
   a reluctor attached to the outer periphery of a rotor member disposed on a crankshaft of the engine; and
   a pulser coil that sequentially generates a positive rising signal and a negative falling signal each time the reluctor passes by during rotation; and
wherein the waveform shaping circuit outputs the rotation pulse signal, which is waveform-shaped into a signal that changes to one of the binary logic levels upon the positive rising signal is input, and waveform-shaped into a signal that changes to the other binary logic level upon the negative falling signal is input.

### Reluctor Configuration and Pulser Coil Arrangement

The engine ignition device,
wherein the pulser coil is disposed adjacent to an arbitrary position on the outer periphery of the rotor member; and
wherein the reluctor is formed on an outer periphery of the rotor member and has a circumferential length such that a leading end of the reluctor is positioned on the pulser coil upon a piston is at the first angle, and a trailing end of the reluctor is positioned on the pulser coil upon the piston is at the second angle.

### Engine Ignition Control Method: Low-Speed Gnition Control

The present invention is a control method for an engine ignition device that repeats intake, compression, combustion, and exhaust, the steps of:
outputting, by a rotational pulse detector, a rotation pulse signal which changes to one of two logic levels at a first angle before top dead center and changes to the other of two logic levels at a second angle closer to top dead center than the first angle for each revolution of the engine;
detecting the engine speed from the period of change in the binary logic level of the rotation pulse signal to one side or the other side by a rotation speed detection unit;
determining a change in the binary logic level of the rotation pulse signal to one of the two values upon the low-speed current control unit determines that the engine is in a low-speed rotation mode where the engine rotation speed is equal to or lower than a threshold rotation speed, and supplying a current to a primary winding of an ignition coil by turning on a switching element to charge energy in the primary winding; and
determining a change in the binary logic level of the rotation pulse signal to the other by a low-speed current cutoff control unit, cutting off the current supplied to the primary winding of the ignition coil by turning off the switching element, generating a high voltage in the secondary winding, and applying the high voltage to the ignition plug to ignite the ignition plug.

### High-Speed Ignition Control

The control method, further, the steps of:
determining, upon a high-speed rotation mode in which the engine rotation speed exceeds the threshold rotation speed is determined by a timer control unit, a change in the binary logic level of the rotation pulse signal to one of the two values, and setting a first timer time until current supply starts in a current start timer and a second timer time until ignition starts in an ignition timer, thereby starting the respective timers;
supplying current to the primary winding of the ignition coil by turning on the switching element by a high-speed current control unit upon the first timer time of the current start timer has elapsed, thereby charging energy; and
using a high-speed current cutoff control unit to cut off the current supplied to the primary winding of the ignition coil by turning off the switching element upon the second timer time of the ignition timer has elapsed, thereby generating a high voltage in the secondary winding, and applying the high voltage to the spark plug to ignite the spark plug.

### Rotational Pulse Detector

The rotational pulse detector in which includes a rotation detector and a waveform shaping circuit;
wherein the rotation detector includes:
   a reluctor attached to the outer periphery of a rotor member disposed on a crankshaft of the engine; and
   a pulser coil that sequentially generates a positive rising signal and a negative falling signal each time the reluctor passes by during rotation; and
wherein the waveform shaping circuit outputs the rotation pulse signal, which is waveform-shaped into a signal that changes to one of the binary logic levels upon the positive rising signal is input, and waveform-shaped into a signal that changes to the other binary logic level upon the negative falling signal is input.

### Reluctor Configuration and Pulser Coil Arrangement

The control method for an engine ignition device,
wherein the pulser coil is disposed adjacent to an arbitrary position on the outer periphery of the rotor member; and
   wherein the reluctor is formed on an outer periphery of the rotor member and has a circumferential length such that a leading end of the reluctor is positioned on the pulser coil upon the piston is at the first angle, and a trailing end of the reluctor is positioned on the pulser coil upon a piston is at the second angle.

### Storage Medium: Low-Speed Ignition Control

The present invention is a non-transitory storage medium storing an engine ignition control program causing a computer to execute:
an input function for inputting, from a rotational pulse detector, a rotation pulse signal that changes to one of two logic levels at a first angle before top dead center and changes to the other logic level at a second angle that is closer to top dead center than the first angle, for each revolution of the engine;
a rotation speed detection function for detecting the engine rotation speed from the period of change in the binary logic level of the rotation pulse signal to one side or the other side;
a low-speed current control function that determines whether the rotation pulse signal changes to one of the binary logic levels upon a low-speed rotation mode is determined in which the rotation speed of the engine is equal to or lower than a threshold rotation speed, and turns on a switching element to supply a current to the primary winding of the ignition coil to charge energy; and
a low-speed current control function that determines whether the binary logic level of the rotation pulse signal changes to the other, cuts off the current supplied to the primary winding of the ignition coil by turning off the switching element, generates a high voltage in a secondary winding, and applies the high voltage to the spark plug to ignite the spark plug.

### High-Speed Mode Ignition Control

The non-transitory storage medium, further:
a timer control function that, upon it is determined that the engine is in a high-speed rotation mode in which the engine rotation speed exceeds the threshold rotation speed, determines whether the binary logic level of the rotation pulse signal changes to one of the two values, and sets a first timer time until current supply starts in a current start timer, and sets a second timer time until ignition starts in an ignition timer, thereby activating the timers;
a high-speed current control function that, upon the first timer time of the current start timer has elapsed, determines the rising edge of the rotation pulse signal and turns on a switching element to supply a current to the primary winding of an ignition coil to charge energy; and
a high-speed current cutoff function that, upon the second timer time of the ignition timer has elapsed, cuts off the current supplied to the primary winding of the ignition coil by turning off the switching element, generates a high voltage in the secondary winding, and applies the high voltage to the spark plug to ignite the spark plug.

### Effect of Engine Ignition Device

The present invention is an engine ignition device that repeats intake, compression, combustion, and exhaust, comprising:
a rotational pulse detector that outputs a rotation pulse signal that changes to one of two logic levels at a first angle before top dead center and changes to the other of two logic levels at a second angle that is closer to top dead center than the first angle, for each revolution of the engine;
a rotation speed detection unit that detects the engine rotation speed from the period of change in the binary logic level of the rotation pulse signal to one side or the other side;
a low-speed current control unit that, upon a low-speed rotation mode in which the engine rotation speed is equal to or lower than a threshold rotation speed is determined, determines whether the rotation pulse signal changes to one of the binary logic levels and turns on a switching element to supply a current to a primary winding of an ignition coil, thereby charging energy in the primary winding; and
a low-speed current cutoff control unit that determines whether the binary logic level of the rotation pulse signal changes to the other, cuts off the supply of current to the primary winding of the ignition coil by turning off the switching element, generates a high voltage in a secondary winding, and applies the high voltage to the spark plug to ignite the spark plug.

Therefore, according to the present invention, during low rotation speeds, including upon the engine is starting, energy can be charged by current supplied to the primary winding of the ignition coil and subsequent ignition output can be achieved at fixed timing based on a first angle before top dead center detected by the rotation speed detection unit and a second angle closer to top dead center. As a result, even if the rotation speed changes suddenly during low rotation speeds, ignition output is reliably performed at the ignition angle that is the fixed target position, making it possible to improve engine startability.

### Effect of High-Speed Ignition Control

The engine ignition device further comprising:
a timer control unit that, upon a high-speed rotation mode in which the rotation speed of the engine exceeds the threshold rotation speed is determined, determines whether the binary logic level of the rotation pulse signal changes to one of the two values, and sets a current start timer to a first timer time until current supply starts, and sets an ignition timer to a second timer time until ignition starts, thereby activating the timers;
a high-speed current control unit that supplies current to the primary winding of the ignition coil by turning on the switching element upon the first timer time of the current start timer has elapsed, thereby charging energy in the primary winding; and
a high-speed current cutoff control unit that, upon the second timer time of the ignition timer has elapsed, cuts off the current supplied to the primary winding of the ignition coil by turning off the switching element, generates a high voltage in the secondary winding, and applies the high voltage to the spark plug to ignite the spark plug.

Therefore, during high-speed rotation, the timer is set with the first angle before top dead center detected by the rotation speed detection unit as the starting point, and the time until current supply begins and the time until ignition are set according to the rotation speed at that time. The timer controls the supply and cut-off of current supply (energization and cut-off) to the primary winding of the ignition coil, generating a high voltage in the secondary winding, which ignites the spark plug. As a result, ignition output is performed at the ignition angle that is the targeted position according to the engine rotation speed, enabling stable ignition control after the engine starts.

### Effect of the Rotational Pulse Detector

The rotational pulse detector in which includes a rotation detector and a waveform shaping circuit;
wherein the rotation detector includes:
   a reluctor attached to the outer periphery of a rotor member disposed on a crankshaft of the engine; and
   a pulser coil that sequentially generates a positive rising signal and a negative falling signal each time the reluctor passes by during rotation; and
wherein the waveform shaping circuit outputs the rotation pulse signal, which is waveform-shaped into a signal that changes to one of the binary logic levels upon the positive rising signal is input, and waveform-shaped into a signal that changes to the other binary logic level upon the negative falling signal is input.

Therefore, upon the engine is running at low speed after starting, the timing upon the tip of the reluctor passes over the pulser coil, which is positioned at the first angle before dead center, is the timing upon current begins to be supplied to the primary winding of the ignition coil, the time it takes for the circumference of the reluctor to pass over the pulser coil is the time upon current is supplied to the primary winding, and the timing upon the rear end of the reluctor passes over the pulser coil is the timing upon the current being supplied to the primary winding is cut off and ignition is performed with the high voltage of the secondary winding. As a result, due to the fixed timing determined by the first angle and the second angle before top dead center, it is possible to ignite at the timing of the targeted ignition angle even if the rotation speed changes suddenly.

### Effects of Engine Ignition Device Control Method, Program, and Strage Medium

The control method for an engine ignition device and the non-transitory storage medium storing an engine ignition control program according to the present invention also provide the same effects as those of the engine ignition device described above.

### BRIEF DESCRIPTION OF THE DRAWINGS

FIG. 1 is an explanatory diagram showing an embodiment of an engine ignition device.

FIG. 2 is an explanatory diagram showing the configuration of a rotation detector.

FIGS. 3A to 3E are time charts showing ignition control in a low-speed rotation mode according to the embodimentof FIG. 1.

FIGS. 4A to 4G are time charts showing ignition control in the high-speed rotation mode according to the embodiment.

FIG. 5 is a flowchart showing ignition control by a control unit of an ignition device of FIG. 1.

FIGS. 6A to 6G are time charts showing ignition control by a conventional ignition control device.

### DETAILED DESCRIPTION EMBODEIMENTS OF THE INVENTION

Hereinafter, embodiments of an engine ignition device, a control method thereof, a control program, and a storage medium for the control program according to the present invention will be described in detail with reference to the accompanying drawings. Note that the present invention is not limited to the following embodiments.

### Basic Concept of the Embodiment

First, the basic concept of the embodiment will be described. The embodiment generally relates to an engine ignition device for a portable engine generator, a motorcycle, or the like, a control method thereof, a control program, and a storage medium for the control program.

Here, the engine ignition device is a device that, upon a switching element is turned on, causes a current to flow through the primary winding of the ignition coil to charge it with energy, and upon the switching element is turned off, cuts off the current flowing through the primary winding, generates a high voltage in the secondary winding of the ignition coil, and applies this high voltage to the spark plug to ignite it. Note that passing a current through the primary winding of the ignition coil means supplying a current to the primary winding of the ignition coil, and cutting off the current flowing through the primary winding means cutting off the current being supplied to the primary winding. In addition, the engine ignition device of the embodiment is a “transistor controlled ignition device (TCI)” in which the “switching element” is a “transistor.”

The engine ignition device of the embodiment includes a control unit that is configured with a rotation detector, a waveform shaping circuit, and a computer circuit. The rotation detector and the waveform shaping circuit configure a rotation pulse detection unit.

Here, the rotation detector is a rotation sensor that outputs a rotation detection signal that changes positive and negative at a predetermined rotation angle position of the engine, and outputs a rotation detection signal that rises positive at a first angle before top dead center and falls negative at a second angle that is closer to top dead center than the first angle for each engine revolution.

The rotation detector is composed of a pulser coil and a reluctor. Here, the reluctor is a circumferential protrusion provided on the outer periphery of a rotor member disposed on the crankshaft of the engine. The pulser coil is a rotation sensor that is disposed close to the rotational position of the reluctor and generates a positive rising signal and a negative falling signal in sequence each time the reluctor passes by during rotation. The Top Dead Center is abbreviated as TDC, and the Before Top Dead Center is abbreviated as BTDC.

The pulser coil is disposed adjacent to an arbitrary position on the outer periphery of a rotor member connected to the crankshaft of the engine. The reluctor is formed on the outer periphery of the rotor member so that reluctor's circumferential length is such that its leading end is positioned at the pulsar coil when the piston is at a first angle before top dead center, and reluctor's trailing end is positioned at the pulsar coil when the piston is at a second angle before top dead center.

In addition, the waveform shaping circuit generates a rotation pulse signal that changes to one of the binary logic values, for example, an H level, at the timing of the first angle, and to the other binary logic value, for example, an L level, at the timing of the second angle, based on the rotation detection signal output from the rotation detector.

The ignition control unit controls ignition at a predetermined ignition angle just before top dead center, and although the configuration is arbitrary, it is made up of a low-speed ignition control unit and a high-speed ignition control unit. In this application, engine rotation speed is synonymous with rotation number, low speed is synonymous with low rotation and low rotation speed, and high speed is synonymous with high rotation and high rotation speed.

Here, the low-speed ignition control unit is composed of a low-speed crrent control unit and a low-speed current cutoff control unit.

Upon the low-speed rotation mode, in which the engine speed is equal to or lower than the threshold rotation speed, is determined, the low-speed current control unit detects a change in the binary logic level of the rotation pulse signal to one of the two values, for example, a rising edge to H level, and turns on the switching element to supply the primary winding of the ignition coil, thereby charging energy.

In addition, the low-speed current cut-off control unit detects a change in the binary logic level of the rotation pulse signal to the other side, for example, a falling edge to L level, and cuts off the current supplied to the primary winding of the ignition coil by turning off the switching element, generating a high voltage in the secondary winding, and applies this high voltage to the spark plug to ignite the ignition element.

Therefore, at low engine speeds, including upon the engine is starting, energy can be charged by supplying current to the primary winding of the ignition coil and then ignited at fixed timing based on a first angle before top dead center detected by the rotation detector and a second angle closer to top dead center. As a result, even if the rotation speed changes suddenly during low rotation speeds, ignition output is performed at an ignition angle that is a fixed target position, making it possible to improve engine startability.

The high-speed ignition control unit is composed of a timer control unit, a high-speed current control unit, and a high-speed current cutoff control unit.

Upon the timer control unit determines that the engine is in high-speed rotation mode, where the engine speed exceeds a threshold rotation speed, it determines whether the rotation pulse signal changes to one of the binary logic levels, for example, a rising edge to H level, and sets a first timer time (the time from the rising edge to the start of current supply) in a current start timer, and sets a second timer time (the time from the detection of the rising edge to ignition) in an ignition timer, and starts each timer.

Upon the first timer time of the current-start timer has elapsed, the high-speed current control unit turns on the switching element to supply a current to the primary winding of the ignition coil, thereby charging energy.

Upon the second timer time of the ignition timer has elapsed, the high-speed current cut-off control unit cuts off the current supply to the primary winding of the ignition coil by turning off the switching element, generating a high voltage in the secondary winding, and applies the high voltage to the spark plug to ignite the spark plug.

Therefore, during high-speed rotation, the timers are set with a first angle before top dead center detected by the rotation detector as the starting point, and a first timer time until current supply corresponding to the rotation speed at that time and a second timer time until ignition are set. Then, ignition is performed by supplying current to the primary winding of the ignition coil and cutting off the current supply through timer control, generating a high voltage in the secondary winding. As a result, ignition output is performed at the ignition angle that is the targeted position according to the engine rotation speed, enabling stable ignition control during generator load operation after the engine has started.

The embodiment also provides a control method for an engine ignition device, which, like the engine ignition device described above, includes a rotation detector, a waveform shaping circuit, and an ignition control unit, and performs ignition control of the engine ignition device.

Furthermore, the embodiment provides a non-transitory storage medium storing an engine ignition control program causing a computer to execute an engine ignition control function.

A specific embodiment will be described below. In the specific embodiment shown below, the “engine ignition device” is a “portable engine generator,” the “ignition device” is a “transistor ignition device,” the “rotation detector” is composed of “one reluctor and a pulser coil,” the “first angle” is “75° before top dead center,” and the “second angle” is “15° before top dead center.”

Hereinafter, specific embodiments of the engine ignition device will be described in detail. The contents will be divided into the following sections.
a. Engine ignition device
b. Rotation detector
c. Ignition control in low-speed rotation mode
d. Ignition control in high-speed rotation mode
e. Ignition control by control unit
f. Non-transitory storage medium storing an engine ignition control program Ignition
g. Modifications of the present invention

### a. Engine Ignition Device

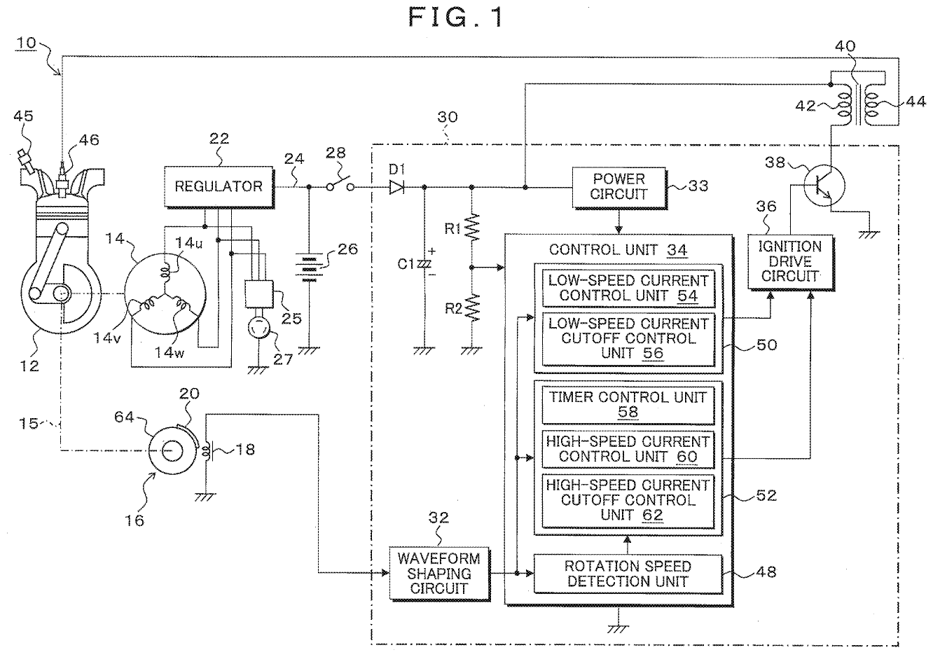

First, the engine ignition device will be described with reference to FIG. 1, which is a circuit block diagram showing an embodiment of the engine ignition device.

As shown in FIG. 1, the engine ignition device 10 includes, as main elements, an engine 12, an AC generator 14, a rotation detector 16, a regulator 22, an inverter 25, a battery 26, a connector 27, an ignition switch 28, a circuit module 30, an ignition drive circuit 36, an NPN transistor 38, and an ignition coil 40, and constitutes, for example, a portable engine generator. The engine displacement and power generation output of the portable engine generator of the embodiment are arbitrary, but are, for example, 120 cc and 1.8 kW.

The circuit module 30 is provided with a charging circuit having a diode D1 and a capacitor C1, a resistor voltage divider circuit in which resistors R1 and R2 are connected in series, a waveform shaping circuit 32, a power supply circuit 33, a control unit 34 using a computer circuit, the ignition drive circuit 36, and the transistor 38. The rotation detector 16 and the waveform shaping circuit 32 form a rotation pulse detection unit.

The engine 12 is, for example, a single-cylinder, four-stroke engine, and is started by the user pulling the starting grip of a recoil starter. Once started, the engine 12 injects gasoline from an injector 45 into the cylinder chamber during the intake stroke upon the piston descends, ignites it with the spark plug 46 just before top dead center during the compression stroke upon the piston ascends, and then exhausts the combustion gas during the exhaust stroke upon the piston ascends, repeating this cycle.

The AC generator 14 is, for example, a three-phase AC generator, and is rotationally driven by the engine 12. The AC generator 14 has three-phase coils 14U, 14V and 14W fixedly disposed around a rotor formed of a permanent magnet. A three-phase AC voltage induced in the three-phase coils 14U, 14V and 14W of the AC generator 14 is rectified and voltage-regulated by the regulator 22, converted into a DC voltage, and supplied to a power line 24. The three-phase AC voltage from the AC generator 14 is input to the inverter 25, converted into a single-phase 100V AC voltage, and output to a connector 27.

The battery 26 has a positive terminal connected to the power line 24 and a negative terminal grounded. The battery 26 is charged via the regulator 22 by the output voltage from the engine-driven AC generator 14.

The positive terminal of the battery 26 is connected to the circuit module 30 via the ignition switch 28, and supplies a DC power supply voltage to the control unit 34 and the ignition coil 40. The ignition switch 28 is a start switch whose contacts are turned on upon starting the engine.

The AC generator 14 is also provided with a rotation detector 16 that detects the ignition timing of the engine 12. The rotation detector 16 is composed of a pulser coil 18 and a reluctor 20. The reluctor 20 is formed on the outer periphery of a crank pulse rotor (rotor member) 64 that is connected to the crankshaft 15 of the engine 12. The pulser coil 18 is disposed close to the rotation position of the reluctor 20, and a pickup coil is wound around the iron core.

The ignition coil 40 has a primary winding 42 and a secondary winding 44. The primary winding 42 and the secondary winding 44 have one end connected together and are also connected to the power supply line 24 that connects the cathode of the diode D1 and the positive terminal of the capacitor C1.

The other end of the secondary winding 44 of the ignition coil 40 is connected to a high-voltage terminal of an ignition plug 46 of the engine 12, and the low-voltage terminal of the ignition plug 46 is grounded. The other end of the primary winding 42 is connected to a collector terminal of a transistor 38. The transistor 38 is a switching element for supplying or cutting off the primary current flowing through the primary winding 42 of the ignition coil 40. The emitter terminal of the transistor 38 is grounded, and a drive signal is input to the base terminal from the ignition drive circuit 36.

The control unit 34 outputs an ignition drive signal to the ignition drive circuit 36 to turn on the transistor 38, thereby causing a primary current to flow through the primary winding 42 of the ignition coil 40 and charging energy, and then turns off the transistor 38 to generate a high voltage in the secondary winding 44, which is applied to the spark plug 46, thereby performing ignition control to cause ignition.

The anode of diode D1 is connected to the output terminal of the regulator 22 and the positive terminal of battery 26 via ignition switch 28. The cathode of diode D1 is connected to the positive terminal of capacitor C1 and to the common connection terminal of primary winding 42 and secondary winding 44 of ignition coil 40. Capacitor C1 is an electrolytic capacitor and is charged from both the regulator 22 and the battery 26 via diode D1.

The charging voltage of the capacitor C1 becomes the input voltage of the power supply circuit 33, and the constant DC power supply voltage controlled by the power supply circuit 33 is supplied to the control unit.

The waveform shaping circuit 32 shapes the waveform of the output signal from the rotation detector 16 and converts it into a rotation pulse signal that can be processed by the control unit 34. The rotation detector 16 outputs a positive rising signal and a negative falling signal in response to a change in the magnetic field upon the reluctor 20, rotated by the crank pulse rotor 64 of the engine 12, passes through the pulser coil 18.

The waveform shaping circuit 32 outputs a rotation pulse signal that rises to H level upon a positive rising signal is input, and falls to L level upon a negative falling signal is input.

A resistor voltage divider circuit made of resistors R1 and R2 is connected between the positive terminal of capacitor C1 and the ground, and the divided battery voltage is input to the control unit 34. The control unit 34 determines the increase or decrease in the power generation load based on the battery voltage input as a divided voltage and controls the fuel injection from the injector 45 accordingly. That is, upon the power generation load decreases, control unit 34 adjusts the fuel injection from the injector 45 to lower the engine speed, whereas upon the power generation load increases, the control unit 34 adjusts the fuel injection from the injector 45 to raise the engine speed.

The control unit 34 is a computer circuit equipped with a CPU, memory (ROM, RAM), an A/D converter, and various input/output ports, and is provided with an engine speed detection unit 48, a low-speed ignition control unit 50, and a high-speed ignition control unit 52 as functions realized by the CPU executing a program.

The low-speed ignition control unit 50 also has the functions of a low-speed current control unit 54 and a low-speed current cutoff control unit 56. The high-speed ignition control unit 52 also has the functions of a timer control unit 58, a high-speed current control unit 60, and a high-speed current cutoff control unit 62.

The rotation speed detection unit 48 receives the rotation pulse signal from the waveform shaping circuit 32 and detects the engine speed N (rpm) as the reciprocal of the period of the rising edge of the rotation pulse signal to H level that is input for each revolution of the engine 12. The engine speed N detected by the rotation speed detection unit 48 is provided to the low-speed ignition control unit 50 and the high-speed ignition control unit 52.

Upon the low speed mode is determined, in which the rotation speed N from the rotation speed detection unit 48 is equal to or lower than the threshold rotation speed, the low-speed current control unit 54 detects the rising edge of the rotation pulse signal input from the waveform shaping circuit 32 to H level and outputs an ignition drive signal to the ignition drive circuit 36. Then, the transistor 38 is turned on, a current is supplied to the primary winding 42 of the ignition coil 40, causing it to chargeenergy.

The low-speed current cutoff control unit 56 detects the falling edge of the rotation pulse signal input from the waveform shaping circuit 32, which changes from H level to L level, and stops the ignition drive signal being output to the ignition drive circuit 36. Then, by turning off the transistor 38, the current supply to the primary winding 42 of the ignition coil 40 is cut off, a high voltage is generated in the secondary winding 44, and a high voltage is applied to the spark plug 46, causing the spark plug to ignite.

Here, the threshold rotation speed Nth for determining the low-speed rotation mode determined by the low-speed current control unit 54 is arbitrary depending on the characteristics and performance of the engine 12, but since the engine 12 increases and stabilizes at an idle speed (no load operation) of, for example, several hundred rpm to about 3500 rpm upon started, the threshold rotation speed is, for example, in the range of 0 to 1200 rpm, for example, 1000 rpm, and if it is 1000 rpm or less, it is determined to be in the low rotation mode.

### b. Rotation Detector

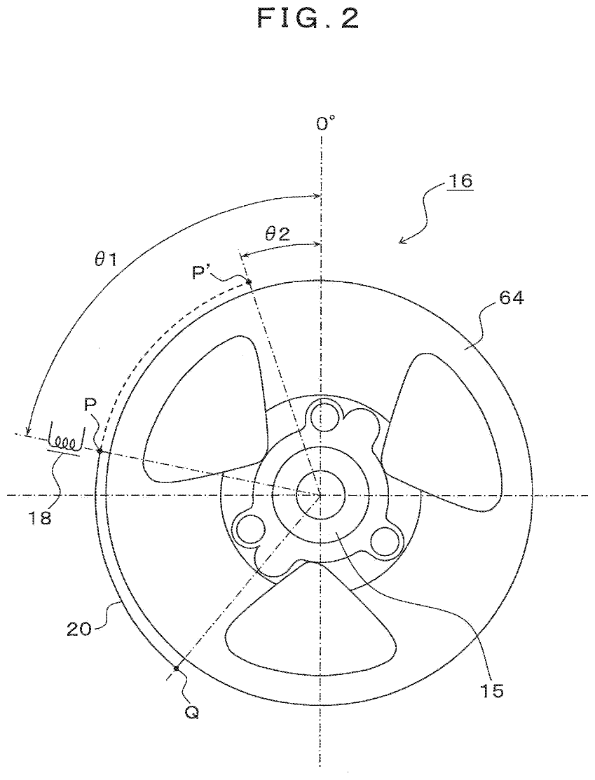

Next, the rotation detector will be described with reference to FIG. 2. In FIG. 2, the rotation detector 16 has the reluctor 20 fixed to the outer periphery of a crank pulse rotor 64 connected to a crankshaft 15 of the engine 12. A pulser coil 18 is positioned adjacent to a predetermined position through which the reluctor 20 rotates.

Here, assuming that the top dead center (TDC) of the piston is a rotation angle of 0° and the crank pulse rotor 64 rotates clockwise, in order to perform current control in the low-speed rotation mode, the angle of point P before the top dead center is set to the first angle θ1 before the top dead center for starting current supply to the primary winding 42 of the ignition coil 40.

Furthermore, the angle of point P′, which is closer to top dead center than point P, is set as a second angle θ2 before top dead center, at which current to the primary winding 42 of the ignition coil 40 is cut off and a voltage is generated in the secondary winding 44 to cause ignition. The second angle θ2 is the ignition angle targeted by ignition control.

The first angle Θ1 and the second angle Θ2 before top dead center are arbitrary, but in this embodiment, the first angle θ1 before top dead center is 75° (BTDC 75°), and the second angle θ2 before top dead center is 15° (BTDC 15°).

Therefore, the pulser coil 18 is positioned closely to correspond to the angular position of the first angle θ1 before top dead center, so that a rising signal can be obtained at the first angle θ1 before top dead center. Furthermore, the reluctor 20 only needs to reach the pulser coil 18 upon the piston is at top dead center. For this reason, as shown in the FIG. 2, the reluctor 20 is fixed to the outer periphery of the crank pulse rotor 64 so that a front end P of the reluctor 20 is at the first angle θ1 before top dead center.

Furthermore, to obtain a falling signal at the second angle θ2 before top dead center, a rear end Q of the reluctor 20 must reach the pulser coil 18 upon the front end P of the reluctor 20 reaches the second angle θ2 before top dead center as shown by the dotted line. Therefore, the reluctor 20 must have a circumferential width (length in the circumferential direction) corresponding to the angle difference θ1-θ2 (=60°) between the first angle θ1 before top dead center and the second angle θ2° before top dead center.

The position of the pulser coil 18 relative to the crank pulse rotor 64 is arbitrary, and the reluctor 20 may be provided on the outer periphery of the crank pulse rotor 64 so that reluctor's circumferential length is such that reluctor's leading end P is located at the pulser coil 18 upon the piston is at the first angle θ1 before top dead center, and the rear end Q is located at the pulser coil 18 upon the piston is at the second angle θ2 before top dead center.

With such an arrangement of the pulser coil 18 and the arrangement and configuration of the reluctor 20, upon the front end P of the reluctor 20 reaches the first angle θ1 before top dead center and passes in front of the pulser coil 18, the magnetic field applied to the pulser coil 18 increases, a positive rising signal is generated in the pulser coil 18 due to electromagnetic induction, and the rotation pulse signal output from the waveform shaping circuit 32 rises from L level to H level.

Next, the reluctor 20 rotates due to the crank pulse rotor 64, and upon the front end P of the reluctor 20 reaches the second angle θ2 before top dead center, as shown by the dotted line, the rear end Q of the reluctor 20 reaches the first angle θ1 before top dead center, the magnetic field applied to the pulser coil 18 decreases, a negative falling signal is generated in the pulser coil 18 due to electromagnetic induction, and the rotation pulse signal output from the waveform shaping circuit 32 falls from H level to L level.

Therefore, as explained in the low-speed current control unit 54 of FIG. 1, the rising edge of the rotation pulse signal to the H level is detected, and the transistor 38 is turned on to supply the primary winding 42 of the ignition coil 40, thereby charging energy. Next, as explained in the low-speed current control unit 56 of FIG. 1, the falling edge of the rotation pulse signal to the L level is detected, and the transistor 38 is turned off to cut off the current supply to the primary winding 42, generating a high voltage in the secondary winding 44, which is then applied to the spark plug 46 to ignite the spark plug.

### c. Ignition Control in Low-Speed Rotation Mode

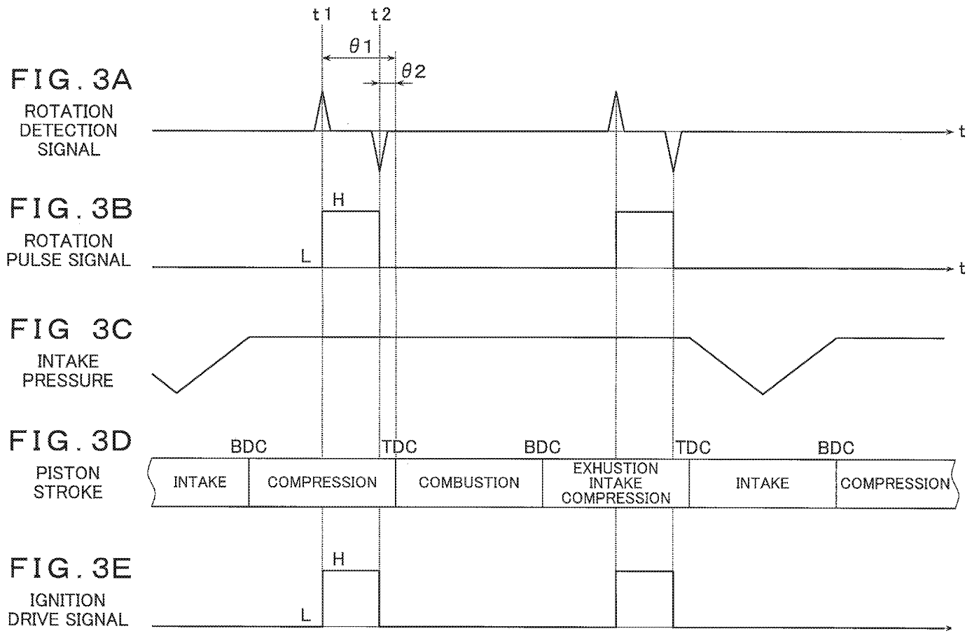

Next, ignition control in the low-speed rotation mode will be explained. In this explanation, reference will be made to FIGS. 3A to 3E, which is a time chart showing ignition control in the low-speed rotation mode by the engine ignition device of this embodiment. FIG. 3A shows a rotation detection signal (pulsar coil detection signal), FIG. 3B shows a rotation pulse signal, FIG. 3C shows the intake pressure, FIG. 3D shows a piston stroke, and FIG. 3E shows an ignition drive signal (transistor drive signal).

The low-speed ignition control unit 50 shown in FIG. 1 performs low-speed current control and low-speed current cutoff control upon it is determined that the engine is in a low-speed rotation mode in which the engine speed N from the rotation speed detection unit 48 is equal to or lower than the threshold engine speed Nth.

As shown in FIGS. 3A to 3E, after the engine 12 has started, upon the piston is in the compression stroke, the rotation detector 16 outputs a positive rising signal at time t1 upon the first angle θ1 before top dead center is reached, and the rotation pulse signal from the waveform shaping circuit 32 rises from L level to H level.

Therefore, the low-speed current control unit 54 detects the rising edge of the rotation pulse signal to the H level, outputs an ignition drive signal from the ignition drive circuit 36 to turn on the transistor 38, and supplies current to the primary winding 42 of the ignition coil 40 to charge energy.

Subsequently, the rotation detector 16 outputs a negative falling signal at time t2 upon the rotation angle reaches the second angle θ2 before top dead center, and the rotation pulse signal from the waveform shaping circuit 32 falls to an L level.

Therefore, the low-speed current cutoff control unit 56 detects the falling edge of the rotation pulse signal to the L level, stops the output of the ignition drive signal from the ignition drive circuit 36, cuts off the transistor 38 to cut off the current supplied to the primary winding 42, generates a high voltage in the secondary winding 44, and applies the high voltage to the spark plug 46 to ignite the spark plug 46.

Next, the same ignition control is performed in the exhaust stroke following the combustion stroke, but since no fuel is injected, only ignition occurs and no combustion occurs. Similar control is then repeated.

In this type of ignition control in the low-speed rotation mode, current control of the ignition coil 40 is performed based on the detection of a fixed rotation angle by the rotation detector 16. Therefore, even upon the rotation speed increases rapidly, such as upon starting the engine, ignition is always performed at the second angle θ2 as the targeted ignition angle, eliminating variations in ignition timing and improving startability.

### d. Ignition Control in High-Speed Rotation Mode

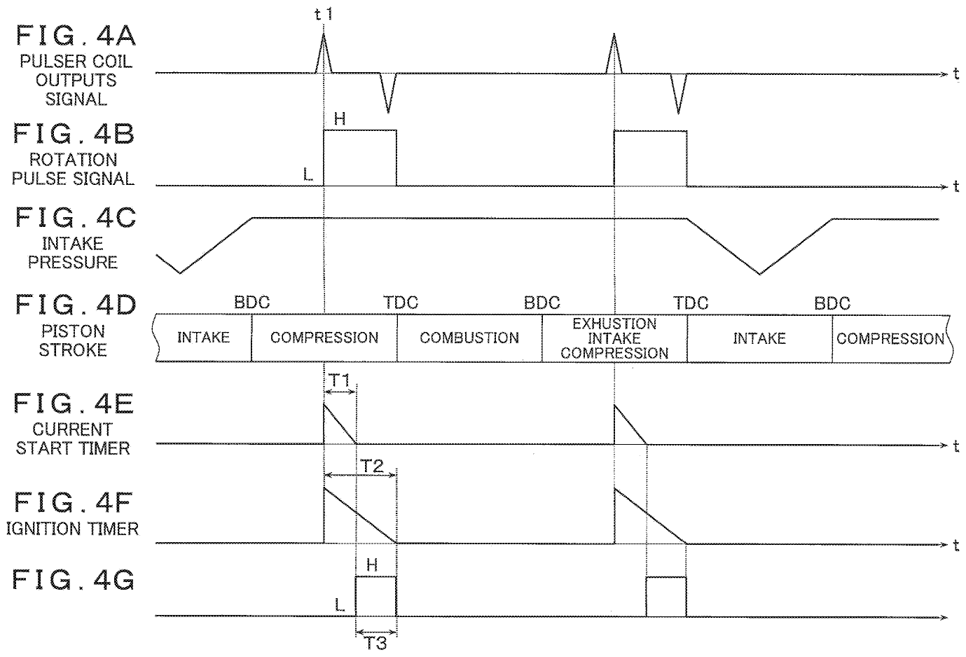

Next, ignition control in the high-speed rotation mode will be explained. In this explanation, reference will be made to FIGS. 4A to 4G, which show time charts of ignition control in the high-speed rotation mode in the engine ignition device of this embodiment. FIG. 4A shows a rotation detection signal (pulsar coil detection signal), FIG. 4B shows a rotation pulse signal, FIG. 4C shows an intake pressure, FIG. 4D shows the piston stroke, FIG. 4E shows a current start timer, FIG. 4F shows a ignition timer, and FIG. 4G shows an ignition drive signal (transistor drive signal).

Here, the time charts for high-speed rotation in FIGS. 4A to 4G and the time charts for low-speed rotation in FIGS. 3A to 3E have the same horizontal axis width, but the time axes are different because the engine speeds are different. Specifically, if the engine speed at low speed in FIGS. 3A to 3E is, for example, 500 rpm and the engine speed at high speed in FIGS. 4A to 4G is, for example, 3500 rpm, the period of the rotation detection signal in FIG. 3A is 120 ms and the period of the rotation detection signal in FIG. 4A is approximately 17 ms.

The high-speed ignition control unit 52 shown in FIG. 1 performs high-speed current control and high-speed current cut-off control using timer control upon the rotation speed N from the rotation speed detection unit 48 exceeds the threshold rotation speed Nth and determines that the high-speed rotation mode is in operation.

As shown in FIGS. 4A to 4G, upon the engine 12 has finished starting and is in high-speed rotation mode and the piston is on the compression stroke, the rotation detector 16 outputs a positive rising signal at time t1 upon the first angle θ1 before top dead center is reached, and the rotation pulse signal from the waveform shaping circuit 32 rises from L level to H level.

Therefore, upon the timer control unit 58 detects the rising edge of the rotation pulse signal to H level at time t1, the ignition angle is set to the second angle θ2 before top dead center, so it calculates the ignition angle (θ1-θ2) from the rising edge detection signal until the ignition angle is reached. Next, the calculated ignition angle (θ1-θ2) is converted into the time T2 from the rotation speed N at that time to ignition using the following equation.

T2=[(θ1-θ2)/360°]·(60 sec/N)

Furthermore, since the time T3 during which current is supplied to the primary winding 42 of the ignition coil 40 is set in advance in accordance with the characteristics of the ignition coil 40, the time T1 from the rising edge of the rotation pulse signal to the start of current supply is calculated using the following equation.

T1=(ignition time T2)−(current flow time T3)

Upon the timer control unit 58 detects a rising edge of the rotation pulse signal at time t1, the timer control unit 58 sets the time T1 until the start of current supply in the current start timer of FIG. 4E, and sets the time T2 until the start of ignition in the ignition timer of FIG. 4F, and starts each timer.

Upon the current start timer reaches the set time T1, the high-speed current control unit 60 outputs an ignition drive signal from the ignition drive circuit 36 to turn on the transistor 38, supplying current to the primary winding 42 of the ignition coil 40 and charging the primary winding with energy.

Next, upon the ignition timer reaches the set time T2, the high-speed current cutoff control unit 62 stops the ignition drive signal output from the ignition drive circuit 36, turns off the transistor 38, and generates a high voltage in the secondary winding 44 of the ignition coil 40. Then, the high voltage is applied to the spark plug 46, causing the spark plug 46 to ignite.

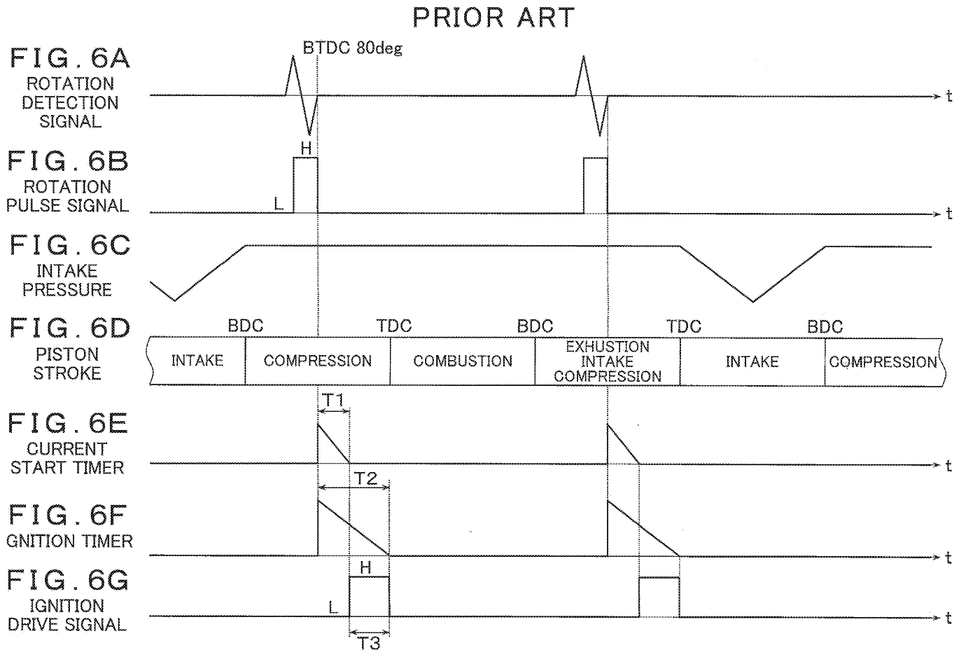

The ignition control in the high-speed rotation mode of this embodiment is similar to the conventional ignition control shown in FIGS. 6A to 6G, but the structure of the reluctor 20 of the rotation detector 16 is different from the conventional one. Therefore, while the conventional ignition control is started by detecting the falling edge of the rotation pulse signal to L level, this embodiment is different in that the ignition control is started by detecting the rising edge of the rotation pulse signal to H level.

### e. Ignition Control by Control Unit

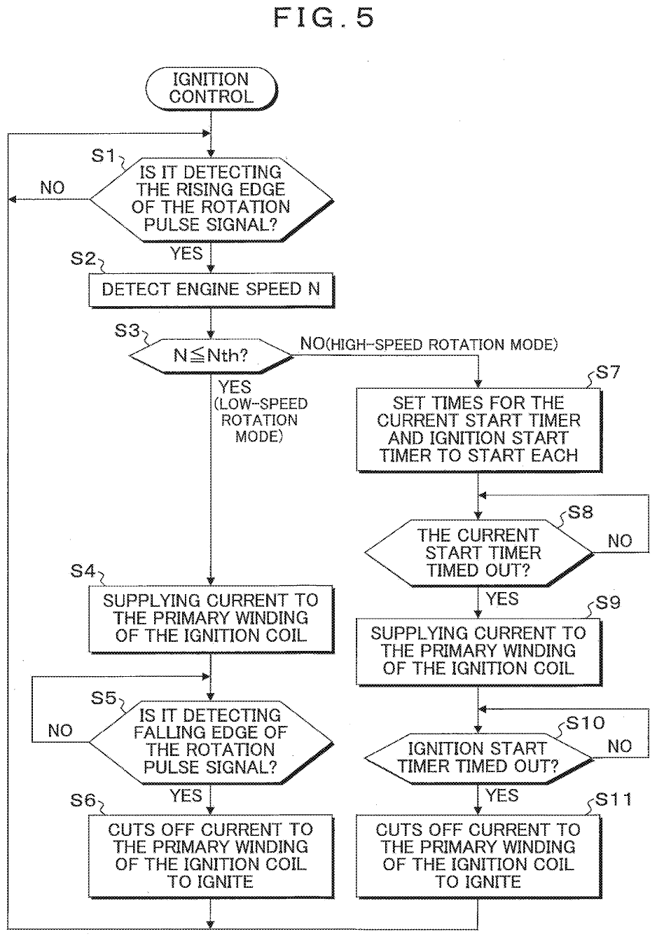

Next, the ignition control by the control unit 34 configured by the computer shown in FIG. 1 will be explained. In this explanation, reference will be made to FIG. 5, which is a flowchart showing the ignition control by the control unit of the engine ignition device shown in FIG. 1. Note that steps S4 to S6 are ignition control in the low-speed rotation mode, and steps S7 to S11 are ignition control in the high-speed rotation mode.

As shown in FIG. 5, upon the control unit 34 detects a rising edge of the rotation pulse signal input from the waveform shaping circuit 32 (step S1), the control unit 34 calculates the elapsed time from the time upon the previous rising edge was detected, i.e., the period, and detects the engine speed N as the reciprocal of the period (step S2).

Next, the engine speed N is compared with a threshold speed Nth, and if it is determined that the engine speed N is equal to or lower than the threshold speed Nth (determined to be in low-speed rotation mode) (Yes in step S3), an ignition control signal is output to the ignition drive circuit 36, the transistor 38 is turned on, and current is supplied to the primary winding 42 of the ignition coil 40 to charge it with energy (step S4).

Next, upon a falling edge of the rotation pulse signal input from the waveform shaping circuit 32 is detected (Yes in step S5), the ignition drive signal output to the ignition drive circuit 36 is stopped, the transistor 38 is turned off to cut off the current supplied to the primary winding 42, a high voltage is generated in the secondary winding 44, and the high voltage is applied to the spark plug 46 to ignite the spark plug 46 (step S6). Thereafter, the same ignition control in the low-speed rotation mode is repeated until the engine rotation speed N exceeds the predetermined threshold rotation speed Nth.

Upon it is determined that the engine speed N exceeds the threshold speed Nth (high-speed rotation mode determination) (No in step S3), a first time T1 from the time upon the rising edge of the rotation pulse signal is detected until the current supply starts is calculated and set in the current start timer, and a second time T2 until the ignition starts is calculated and set in the ignition timer, and each timer is started (step S7).

Next, upon it is determined that the current start timer has timed out (time T1 has elapsed) (Yes in step S8), an ignition control signal is output to the ignition drive circuit 36, the transistor 38 is turned on, and current is supplied to the primary winding 42 of the ignition coil 40, thereby charging energy into the primary winding (step S9).

Next, upon it is determined that the ignition timer has timed out (time T2 has elapsed), the ignition drive signal output to the ignition drive circuit 36 is stopped, the transistor 38 is turned off to cut off the current supplied to the primary winding 42, a high voltage is generated in the secondary winding 44, and the high voltage is applied to the spark plug 46 to ignite the spark plug 46 (step S11). Thereafter, similar high-speed ignition control is repeated as long as the engine speed N exceeds the threshold speed Nth.

### f. Non-Transitory Storage Medium Storing an Engine Ignition Control Program

The storage medium and non-transitory storage medium storing an engine ignition control program causing a computer constituting the control unit 34 to execute the ignition control shown in FIG. 5.

The ignition control program may be stored on the storage medium such as an internal memory, an internal hard disk, or an external hard disk, or may be stored on a storage medium such as a CD-ROM (Compact Disc Read Only Memory), a DVD-ROM (Digital Versatile Disk Read Only Memory), an MO disk (Magneto-Optical disk), or a USB memory (USB (Universal Serial Bus) flash drive).

Upon the ignition control program is stored on a portable storage medium such as a CD-ROM, DVD-ROM, MO disk, or USB memory, it can be used directly or by installing it in memory via a storage medium reading device possessed by the computer uponever necessary.

In addition, the ignition control program can be stored in an external memory area (such as another computer) that can be accessed from the computer system via an information and communication network, and can be used whenever necessary by installing it directly from the external memory area via the information and communication network or in memory.

### g. Modifications of the Present Invention

Modifications of the engine ignition device according to the present invention will now be described. In addition to the above-described embodiment, the engine ignition device according to the present invention includes the following modifications. The same also applies to the control method for the engine ignition device, the engine ignition control program, and the storage medium.

### Ignition Control

In the above embodiment, as shown in the time charts in FIGS. 3A to 3E and 4A to 4G, ignition occurs immediately before the combustion stroke and immediately before the intake stroke. However, ignition control may be selected such that ignition occurs only immediately before the combustion stroke, and no ignition occurs immediately before the intake stroke.

### Detection of Engine rpm

In the above embodiment, engine rpm is detected as the reciprocal of the period (time interval) of the rising edge of the rotation pulse signal. However, it may also be detected as the reciprocal of the period (time interval) of the falling edge of the rotation pulse signal.

### Other

Furthermore, the present invention includes appropriate modifications that do not impair its objectives and advantages, and is not limited to the numerical values shown in the above embodiment.

What is claimed is:

1. An engine ignition device comprising:
a rotational pulse detector that outputs a rotation pulse signal that changes to one of two logic levels at a first angle before top dead center and changes to the other of two logic levels at a second angle that is closer to top dead center than the first angle, for each revolution of the engine;
a rotation speed detection unit that detects the engine rotation speed from the period of change in the binary logic level of the rotation pulse signal to one side or the other side;
a low-speed current control unit that, upon a low-speed rotation mode in which the engine rotation speed is equal to or lower than a threshold rotation speed is determined, determines whether the rotation pulse signal changes to one of the binary logic levels and turns on a switching element to supply a current to a primary winding of an ignition coil, thereby charging energy in the primary winding; and
a low-speed current cutoff control unit that determines whether the binary logic level of the rotation pulse signal changes to the other, cuts off the supply of current to the primary winding of the ignition coil by turning off the switching element, generates a high voltage in a secondary winding, and applies the high voltage to the spark plug to ignite the spark plug.

2. The engine ignition device according to claim 1, further, comprising:
a timer control unit that, upon a high-speed rotation mode in which the rotation speed of the engine exceeds the threshold rotation speed is determined, determines whether the binary logic level of the rotation pulse signal changes to one of the two values, and sets a current start timer to a first timer time until current supply starts, and sets an ignition timer to a second timer time until ignition starts, thereby activating the timers;
a high-speed current control unit that supplies current to the primary winding of the ignition coil by turning on the switching element upon the first timer time of the current start timer has elapsed, thereby charging energy in the primary winding; and
a high-speed current cutoff control unit that, upon the second timer time of the ignition timer has elapsed, cuts off the current supplied to the primary winding of the ignition coil by turning off the switching element, generates a high voltage in the secondary winding, and applies the high voltage to the spark plug to ignite the spark plug.

3. The engine ignition device according to claim 1,
the rotational pulse detector in which includes a rotation detector and a waveform shaping circuit;
wherein the rotation detector includes:
a reluctor attached to the outer periphery of a rotor member disposed on a crankshaft of the engine; and
a pulser coil that sequentially generates a positive rising signal and a negative falling signal each time the reluctor passes by during rotation; and
wherein the waveform shaping circuit outputs the rotation pulse signal, which is waveform-shaped into a signal that changes to one of the binary logic levels upon the positive rising signal is input, and waveform-shaped into a signal that changes to the other binary logic level upon the negative falling signal is input.

4. The engine ignition device according to claim 3,
wherein the pulser coil is disposed adjacent to an arbitrary position on the outer periphery of the rotor member; and
wherein the reluctor is formed on an outer periphery of the rotor member and has a circumferential length such that a leading end of the reluctor is positioned on the pulser coil upon a piston is at the first angle, and a trailing end of the reluctor is positioned on the pulser coil upon the piston is at the second angle.

5. A control method for an engine ignition device, the steps of:
outputting, by a rotational pulse detector, a rotation pulse signal which changes to one of two logic levels at a first angle before top dead center and changes to the other of two logic levels at a second angle closer to top dead center than the first angle for each revolution of the engine;
detecting the engine speed from the period of change in the binary logic level of the rotation pulse signal to one side or the other side by a rotation speed detection unit;
determining a change in the binary logic level of the rotation pulse signal to one of the two values upon a low-speed current control unit determines that the engine is in a low-speed rotation mode where the engine rotation speed is equal to or lower than a threshold rotation speed, and supplying a current to a primary winding of an ignition coil by turning on a switching element to charge energy in the primary winding; and
determining a change in the binary logic level of the rotation pulse signal to the other by a low-speed current cutoff control unit, cutting off the current supplied to the primary winding of the ignition coil by turning off the switching element, generating a high voltage in a secondary winding, and applying the high voltage to the ignition plug to ignite the ignition plug.

6. Tthe control method accoeding to claim 5, further, the steps of:
determining, upon a high-speed rotation mode in which the engine rotation speed exceeds the threshold rotation speed is determined by a timer control unit, a change in the binary logic level of the rotation pulse signal to one of the two values, and setting a first timer time until current supply starts in a current start timer and a second timer time until ignition starts in an ignition timer, thereby starting the respective timers;
supplying current to the primary winding of the ignition coil by turning on the switching element by a high-speed current control unit upon the first timer time of the current start timer has elapsed, thereby charging energy; and
using a high-speed current cutoff control unit to cut off the current supplied to the primary winding of the ignition coil by turning off the switching element upon the second timer time of the ignition timer has elapsed, thereby generating a high voltage in the secondary winding, and applying the high voltage to the spark plug to ignite the spark plug.

7. The control method according to claim 5,
the rotational pulse detector in which includes a rotation detector and a waveform shaping circuit;
wherein the rotation detector includes:
a reluctor attached to the outer periphery of a rotor member disposed on a crankshaft of the engine; and
a pulser coil that sequentially generates a positive rising signal and a negative falling signal each time the reluctor passes by during rotation; and
wherein the waveform shaping circuit outputs the rotation pulse signal, which is waveform-shaped into a signal that changes to one of the binary logic levels upon the positive rising signal is input, and waveform-shaped into a signal that changes to the other binary logic level upon the negative falling signal is input.

8. The control method according to claim 7,
wherein the pulser coil is disposed adjacent to an arbitrary position on the outer periphery of the rotor member; and
wherein the reluctor is formed on an outer periphery of the rotor member and has a circumferential length such that a leading end of the reluctor is positioned on the pulser coil upon a piston is at the first angle, and a trailing end of the reluctor is positioned on the pulser coil upon the piston is at the second angle.

9. A non-transitory storage medium storing an engine ignition control program causing a computer to execute:
an input function for inputting, from a rotational pulse detector, a rotation pulse signal that changes to one of two logic levels at a first angle before top dead center and changes to the other logic level at a second angle that is closer to top dead center than the first angle, for each revolution of the engine;
a rotation speed detection function for detecting the engine rotation speed from the period of change in the binary logic level of the rotation pulse signal to one side or the other side;
a low-speed current control function that determines whether the rotation pulse signal changes to one of the binary logic levels upon a low-speed rotation mode is determined in which the rotation speed of the engine is equal to or lower than a threshold rotation speed, and turns on a switching element to supply a current to the primary winding of the ignition coil to charge energy; and
a low-speed current control function that determines whether the binary logic level of the rotation pulse signal changes to the other, cuts off the current supplied to the primary winding of the ignition coil by turning off the switching element, generates a high voltage in a secondary winding, and applies the high voltage to the spark plug to ignite the spark plug.

10. The non-transitory storage medium according to claim 9, further:
a timer control function that, upon it is determined that the engine is in a high-speed rotation mode in which the engine rotation speed exceeds the threshold rotation speed, determines whether the binary logic level of the rotation pulse signal changes to one of the two values, and sets a first timer time until current supply starts in a current start timer, and sets a second timer time until ignition starts in an ignition timer, thereby activating the timers;
a high-speed current control function that, upon the first timer time of the current start timer has elapsed, determines the rising edge of the rotation pulse signal and turns on a switching element to supply a current to the primary winding of an ignition coil to charge energy; and
a high-speed current cutoff function that, upon the second timer time of the ignition timer has elapsed, cuts off the current supplied to the primary winding of the ignition coil by turning off the switching element, generates a high voltage in the secondary winding, and applies the high voltage to the spark plug to ignite the spark plug.
